(19) United States
(12) Patent Application Publication
(10) Pub. No.: US 2010/0092187 A1
(43) Pub. Date: Apr. 15, 2010

(54) METHOD OF INITIALIZING NEW CONSUMABLE PART ACCORDING TO REPLACEMENT OF OLD CONSUMABLE PART IN IMAGE FORMING APPARATUS, AND IMAGE FORMING APPARATUS AND SYSTEM FOR PERFORMING THE METHOD

(75) Inventors: Ii-su Lee, Hwaseong-si (KR); Young-kak Lim, Gunpo-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/579,688

(22) Filed: Oct. 15, 2009

(30) Foreign Application Priority Data
Oct. 15, 2008 (KR) 10-2008-00101259

(51) Int. Cl. G03G 15/00

(52) U.S. Cl. 399/24

(57) ABSTRACT

A method of initializing an amount of use of a new consumable part according to replacement of an old consumable part and an image forming apparatus and system for performing the method, the method involves, when the old consumable part is replaced by the new consumable part excluding a memory in an image forming apparatus, transmitting identification information of the image forming apparatus and of the consumable part to a management server; determining whether initialization has been already performed on the amount of use of the new consumable part, wherein the determining is conducted by the management server that uses the identification information of the image forming apparatus and of the new consumable part; generating and transmitting an executable file for initialization of the amount of use of the new consumable part, if the initialization has not been performed on the amount of use of the new consumable part; and initializing the new consumable part by using the executable file.

### CROSS-REFERENCE TO RELATED APPLICATIONS

This application claims priority under 35 U.S.C. §119(a) of Korean Patent Application No. 10-2008-0101259, filed on Oct. 15, 2008, in the Korean Intellectual Property Office, the disclosure of which is incorporated herein in its entirety by reference.

### BACKGROUND

1. Field of the Invention

The present general inventive concept relates to a method of initializing an amount of use of a new consumable part, and an image forming apparatus and system for performing the method when an old consumable part is replaced by the new consumable part in the image forming apparatus.

2. Description of the Related Art

In general, an image forming apparatus performs at least one function selected from the group consisting of a printing function, a copying function, a scanning function, and a faxing function. Such an image forming apparatus uses toner ink, a ribbon cartridge, or the like as a consumable part. The consumable part is mounted in the image forming apparatus, and may be replaced at any time. In general, service engineers replace an old consumable part by a new consumable part excluding a memory, but recently, users may directly replace the old consumable part. Also, when the old consumable part is replaced by the new consumable part, an amount of use of the new consumable part is initialized, and this initialization with respect to the amount of use must be performed only once for each new consumable part. However, when a user replaces the old consumable part by the new consumable part, the user may perform the initialization with respect to the amount of use of the new consumable part many times when replacing the old consumable part by the new consumable part, and thus it may not be possible to check the actual amount of use of the new consumable part. This may affect the durability of the image forming apparatus due to excessive use of the new consumable part, such that it is not possible to determine a normal usage status of the image forming apparatus.

### SUMMARY

The present general inventive concept provides a method of initializing an amount of use of a new consumable part, and an image forming apparatus and system to perform the method, whereby it is possible to check an actual amount of use of the new consumable part when an old consumable part is replaced by the new consumable part excluding a memory in an image forming apparatus.

Additional features and utilities of the present general inventive concept will be set forth in part in the description which follows and, in part, will be obvious from the description, or may be learned by practice of the general inventive concept.

The present general inventive concept provides a method of initializing an amount of use of a new consumable part according to replacement of an old consumable part, the method including the operations of transmitting identification information of the new consumable part to a management server, when the old consumable part is replaced by the new consumable part excluding a memory in an image forming apparatus; determining whether initialization has been already performed on the amount of use of the new consumable part, wherein the determining is conducted by the management server using identification information of the image forming apparatus and the identification information of the consumable part; generating and transmitting an executable file for the initialization of the amount of use of the new consumable part, if the initialization has not been performed on the amount of use of the new consumable part; and initializing the amount of use of the new consumable part by using the executable file.

The present general inventive concept provides a computer readable recording medium having recorded thereon a program to execute the method of initializing the consumable part, by using a computer.

The present general inventive concept provides an image forming apparatus to initialize a consumable part according to replacement of an old consumable part, the image forming apparatus including a transceiving unit to transmit identification information of the new consumable part to an external server and to receive an executable file to initialize the amount of use of the consumable part, when the old consumable part is replaced by the new consumable part excluding a memory; a storage unit to store the executable file; an initialization determining unit to determine whether initialization has been already performed on the amount of use of the new consumable part; an initialization executing unit to initialize the amount of use of the new consumable part according to the executable file, based on a result of the determining by the initialization determining unit; and a control unit to control the transceiving unit, the storage unit, the initialization determining unit, and the initialization executing unit to perform respective functions.

The present general inventive concept provides a system to initialize an amount of use of a new consumable part according to replacement of an old consumable part, the system including an image forming apparatus to transmit identification information of the new consumable part and identification information of the image forming apparatus, when the old consumable part is replaced by the new consumable part excluding a memory; a management server to receive the identification information of the consumable part and the identification information of the image forming apparatus from the image forming apparatus, generating and transmitting an executable file to initialize the amount of use of the new consumable part; and a host device to receive the executable file from the management server, executing the executable file, and transmitting to the image forming apparatus an initialization execution command to indicate the initialization of the amount of use of the new consumable part, wherein the image forming apparatus may initialize the amount of use of the new consumable part according to the initialization execution command.

The present general inventive concept provides a method of performing a first time setup of a consumable part of an image forming apparatus, the method comprising broadcasting information unique to the image forming apparatus and consumable part, comparing the information with stored information, and performing a first time setup of the consumable part if the information broadcast does not match with stored information.

The present general inventive concept provides an image forming system including a consumable part, comprising an image forming apparatus to broadcast unique identifiers of the image forming apparatus and consumable part, and a database server to receive the broadcast unique identifiers, determine whether a first time setup of the consumable part has occurred, and transmit a first time setup executable file to the image forming apparatus if the first time setup is deemed necessary.

### BRIEF DESCRIPTION OF THE DRAWINGS

The above and/or other features and utilities of the present general inventive concept will become apparent and more readily appreciated from the following description of the exemplary embodiments, taken in conjunction with the accompanying drawings, in which:

FIG. 1 is a flowchart of a method of initializing an amount of use of a new consumable part when an old consumable part is replaced by the new consumable part, according to an exemplary embodiment of the present general inventive concept;

FIG. 2 is a diagram of a list to illustrate pieces of identification information of image forming apparatuses and of consumable parts respectively corresponding to executable files that are generated in a management server, according to the exemplary embodiment of the present general inventive concept;

FIG. 3 is a diagram of an updated version of the list of FIG. 2 when an executable file is generated in the management server, according to the exemplary embodiment of the present general inventive concept;

FIG. 4 is a block diagram of an image forming apparatus to perform a method of initializing an amount of use of a new consumable part when an old consumable part is replaced by the new consumable part, according to an exemplary embodiment of the present general inventive concept; and

FIG. 5 is a block diagram of a system to perform a method of initializing an amount of use of a new consumable part when an old consumable part is replaced by the new consumable part, according to an embodiment of the present general inventive concept.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

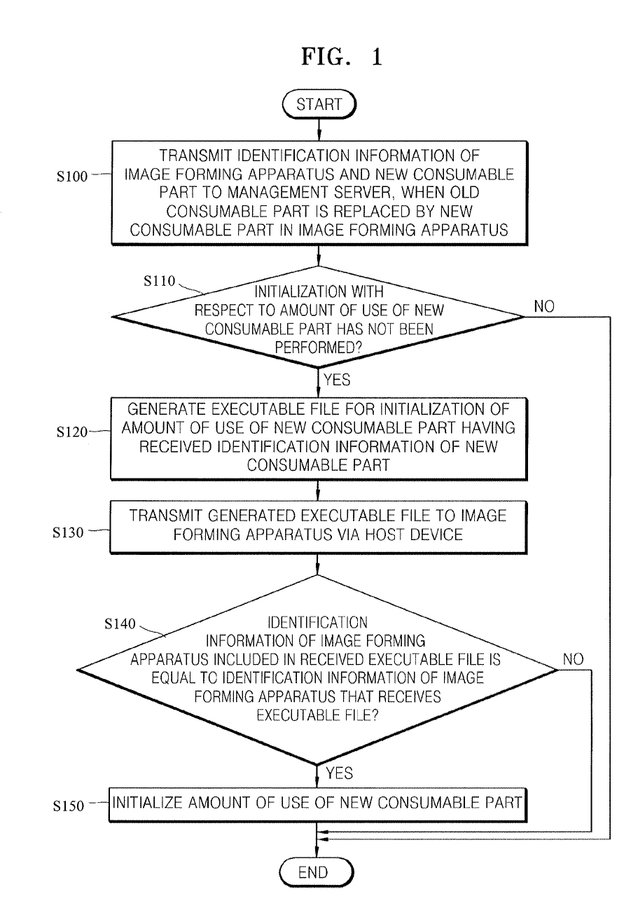

FIG. 1 is a flowchart of a method of initializing an amount of use of a new consumable part when an old consumable part is replaced by the new consumable part, according to an exemplary embodiment of the present general inventive concept.

In operation S100, when the old consumable part is replaced by the new consumable part in an image forming apparatus, identification information of the image forming apparatus and of the new consumable part may be transmitted to a management server. The management server may comprise of a database server. Further, when the old consumable part mounted in the image forming apparatus is replaced by the new consumable part, the identification information of the image forming apparatus and of the new consumable part may be transmitted to the management server. Here, the identification information of the image forming apparatus and of the new consumable part may distinguish from other image forming apparatuses and consumable parts, and such identification information may include serial numbers, names of manufacturers, serial numbers of the manufacturers, manufacture dates, or the like with respect to the image forming apparatus and the new consumable part. Also, the new consumable part does not include a memory, and the management server may include all types of servers and devices that may be connected to the image forming apparatus in a wired or wireless manner.

In operation S110, the management server may check the identification information of the image forming apparatus and of the new consumable part, and determine whether initialization with respect to the amount of use of the new consumable part has been performed. Initialization may include a first time setup of the consumable part that involves a specified quantity of use of the new consumable part. The management server according to an exemplary embodiment of the present general inventive concept may generate an executable file for initialization with respect to an amount of use of a consumable part, and may store information about the generated executable file. Here, since the executable file may include identification information of an image forming apparatus and identification information of the consumable part, the management server may store the identification information of the image forming apparatus and of the consumable part, which have performed the initialization with respect to the amount of use, according to the generated executable file.

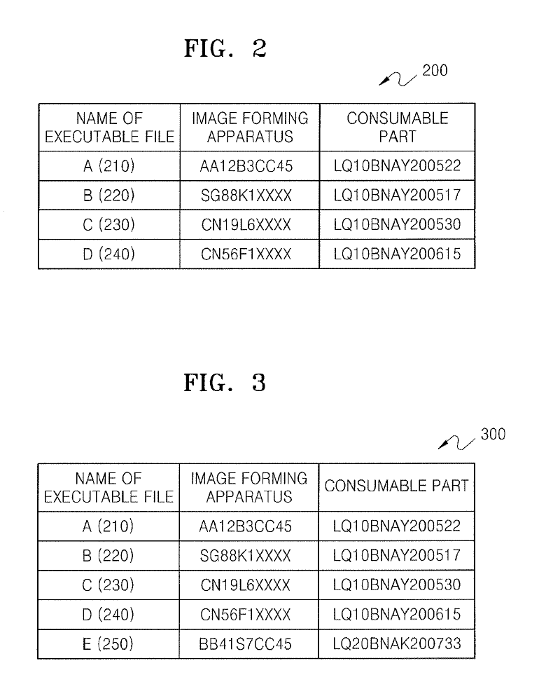

FIG. 2 is a diagram of a list 200 to illustrate pieces of identification information of image forming apparatuses and of consumable parts respectively corresponding to executable files that are generated in the management server, according to an exemplary embodiment of the present general inventive concept.

As illustrated in FIG. 2, in a case where four executable files A (210), B (220), C (230), and D (240) are generated in the management server, the management server may match the pieces of the identification information of image forming apparatuses and of the consumable parts with names of the four executable files. Also, an amount of each of the consumable parts used during initialization by the image forming apparatus may be stored, according to the generated four executable files as well as storage of the plurality of pieces of identification information in the list 200. Referring to FIG. 2, the executable file A (210) may be generated, for example, when an old consumable part is replaced by a consumable part with a serial number of “LQ10BNAY200522” in an image forming apparatus with a serial number of “AA12B3CC45.” Also, the executable file B (220) may be generated when an old consumable part is replaced by a consumable part with a serial number of “LQ10BNAY200517” in an image forming apparatus with a serial number of “SG88K1XXXX.”

Referring back to operation S110, the method involves comparing the identification information of the new consumable part with identification information of consumable parts that is stored in a list in the management server, and determining whether the initialization with respect to the amount of use of the new consumable part has been performed. For example, referring to FIG. 2, in a case where a serial number of a consumable part is “LQ10BNAY200517,” since a serial number matching the serial number of the consumable part exists in the list 200, the method involves determining that initialization with respect to an amount of use of the consumable part has been already performed. That is, using the executable file B (220), it may be possible to know that the initialization with respect to the amount of use of the consumable part with the serial number of “LQ10BNAY200517” has been already performed in the image forming apparatus with the serial number of “SG88K1XXXX .” On the other hand, in a case where the serial number of the consumable part is “LQ20BNAK200733,” since a serial number matching the serial number of the consumable part does not exist in the list 200 that is stored in the management server, the method may involve determining that the initialization with respect to the amount of use of the consumable part with the serial number of “LQ10BNAY200517” has not been performed. According to operation S110, if the initialization with respect to the amount of use of the new consumable part has not been performed, operation S120 may be performed, or if the initialization has been already performed, the method may end.

In operation S120, an executable file for the initialization of the amount of use of the new consumable part is generated. At this time, the executable file may include the identification information of the image forming apparatus and of the new consumable part. Also, when the executable file is generated, the identification information of the image forming apparatus and of the new consumable part included in the generated executable file may be added to the list in the management server so that the list is updated.

FIG. 3 is a diagram of an updated list 300 of the list 200 of FIG. 2 when an executable file is generated in the management server, according to the exemplary embodiment of the present general inventive concept.

Referring back to operation S120, when an executable file E (250) is generated in the management server so as to initialize an amount of use of a consumable part having a serial number of “LQ20BNAK200733” in an image forming apparatus having a serial number of “BB41S7CC45,” an executable file name (E), the serial number (BB41S7CC45) of the image forming apparatus, and the serial number (LQ20BNAK200733) of the consumable part may be added to the list to update the list 200, as illustrated in FIG. 3.

In operation S130, the executable file may be transmitted to the image forming apparatus via a host device. Here, the host device is connected to the image forming apparatus, and may transmit printing data to the image forming apparatus. The host device may execute the executable file received from the management server, and may transmit an initialization execution command to the image forming apparatus connected to the host device, wherein the command is for the initialization with respect to the amount of use of the new consumable part. Although the executable file generated in the management server may be transmitted to the host device and the initialization execution command may be transmitted to the image forming apparatus via the host device according to the exemplary embodiment of the present general inventive concept, the transmission of the executable file may be not limited thereto and thus the management server may directly transmit the executable file to the image forming apparatus. At this time, the executable file may be attached to an e-mail and then transmitted. When the executable file is transmitted to the image forming apparatus or the host device, the image forming apparatus or the host device may receive the executable file and then may display a receipt of the executable file.

In operation S140, the image forming apparatus may check whether the identification information of the image forming apparatus included in the received executable file, matches with the identification information of the image forming apparatus which receives the executable file. That is, it is checked whether the executable file generated in the management server is transmitted to the correct image forming apparatus to perform the initialization with respect to the amount of use of the new consumable part. According to a result of the check, if the two pieces of identification information match with each other, operation S150 may be performed, and if not, the method may end.

In operation S150, the amount of use of the new consumable part can be initialized. Also, the identification information of the new consumable part, when the amount of use of which is initialized, may be stored in the image forming apparatus. That is, the image forming apparatus can initialize the amount of use of the new consumable part according to the initialization execution command, and may store the identification information of the image forming apparatus and of the new consumable part, which is included in the initialization execution command, in a list such as the list 200 as illustrated in FIG. 2. Thus, when another initialization execution command may be received at a later time, the pieces of identification information of consumable parts stored in the list may be compared with identification information of a consumable part which is included in the other initialization execution command, so that initialization with respect to an amount of use of the consumable part is performed. That is, with respect to a consumable part when an amount of use of which has been already initialized and thus is listed in the list, initialization may not be performed although an initialization execution command is received. In general, the image forming apparatus may store a counter value corresponding to each consumable part. Thus, by resetting the counter value of a corresponding consumable part to “0”, wherein the counter value is stored in the image forming apparatus, an amount of use of the consumable part may be initialized. Such initialization with respect to the amount of use of the consumable part may automatically start or may start when a user inputs an initialization execution command.

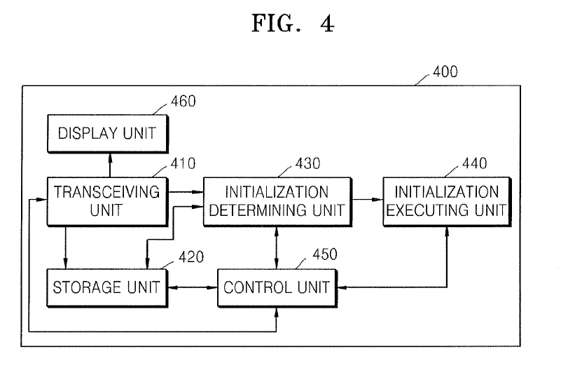

FIG. 4 is a block diagram of an image forming apparatus 400 to perform a method of initializing an amount of use of a consumable part when an old consumable part is replaced by the new consumable part, according to an exemplary embodiment of the present general inventive concept.

As illustrated in FIG. 4, the image forming apparatus 400 according to the present exemplary embodiment may include a transceiving unit 410, a storage unit 420, an initialization determining unit 430, an initialization executing unit 440, a control unit 450, and a display unit 460.

The transceiving unit 410 may transmit identification information of the image forming apparatus 400 and identification information of the new consumable part to an external server when the old consumable part is replaced by the new consumable part in the image forming apparatus 400. To be more specific, when the old consumable part mounted in the image forming apparatus 400 is replaced by the new consumable part, the identification information may read from each of the image forming apparatus 400 and the new consumable part, and the identification information of the image forming apparatus 400 and of the new consumable part may be transmitted to the external server. Here, the identification information of the image forming apparatus 400 and of the new consumable part may include serial numbers, names of manufacturers, serial numbers of the manufacturers, manufacture dates, or the like with respect to the image forming apparatus 400 and the new consumable part. Also, the new consumable part does not include a memory. In addition, the transceiving unit 410 may receive an executable file for the initialization with respect to the amount of use of the new consumable part. Here, the executable file may include identification information of an image forming apparatus that performs initialization with respect to an amount of use of a consumable part, and identification information of the consumable part.

The storage unit 420 may store the identification information of the new consumable part when the amount of use of the new consumable part is initialized by the image forming apparatus 400. That is, when the initialization with respect to the amount of use of the new consumable part is performed according to replacement of the old consumable part in the image forming apparatus 400, the storage unit 420 may store the identification information of the new consumable part when its amount of use is initialized. The storage unit 420 may store the executable file received via the transceiving unit 410. Also, the storage unit 420 may store a counter value corresponding to each of consumable parts.

The initialization determining unit 430 may compare the identification information of the new consumable part with the identification information of the consumable part included in the executable file received via the transceiving unit 410, and thus may determine whether the initialization with respect to the amount of use of the new consumable part has been already performed. Since the storage unit 420 of the image forming apparatus 400 according to the present exemplary embodiment may store one or more pieces of identification information of consumable parts when the amount of use of which has been initialized, as a result of the determination by the initialization determining unit 430, if identification information that matches the identification information of the new consumable part is stored in the storage unit 420, then the initialization with respect to the amount of use of the new consumable part has been already performed. On the other hand, if identification information that matches the identification information of the new consumable part is not stored in the storage unit 420, then the amount of use of the new consumable part has not been initialized. The result of the determination by the initialization determining unit 430 may be transmitted to the initialization executing unit 440.

The initialization executing unit 440 may receive the result of the determination from the initialization determining unit 430, and based on the result of the determination, may initialize the amount of use of the new consumable part. Here, the initialization executing unit 440 may initialize the amount of use of the new consumable part when the identification information of the image forming apparatus included in the received executable file matches the identification information of the image forming apparatus 400 of FIG. 4. To be more specific, the initialization executing unit 440 may reset the counter value of a corresponding consumable part to “0”, wherein the counter value is stored in the storage unit 420, and thus initializes the amount of use of the new consumable part. In addition, the initialization with respect to the amount of use of the new consumable part may be automatically started or may be started when a user inputs an initialization execution command.

The control unit 450 may control the transceiving unit 410, the storage unit 420, the initialization determining unit 430, and the initialization executing unit 440 to perform their own functions.

The display unit 460 may display the received executable file when the executable file is received via the transceiving unit 410.

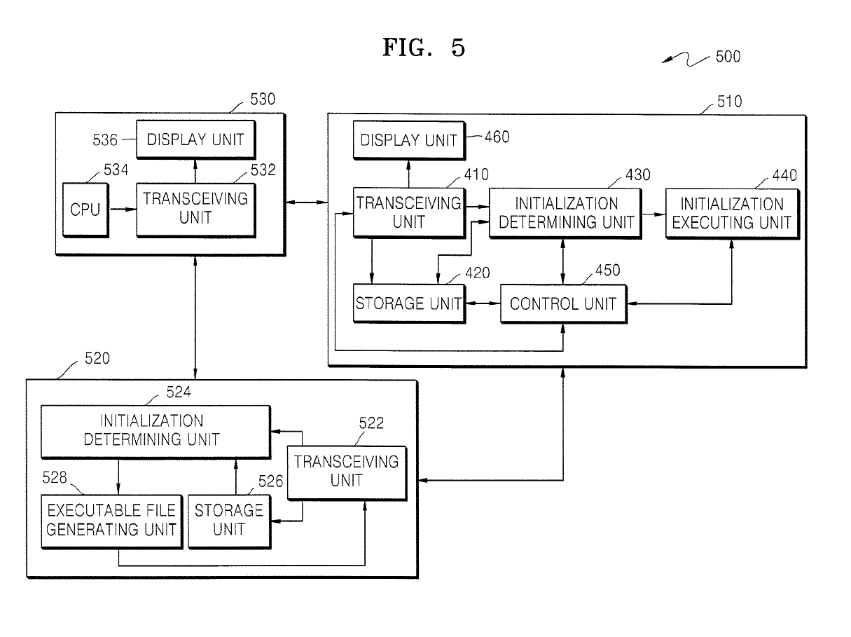

FIG. 5 is a block diagram of a system 500 to perform a method of initializing an amount of use of a new consumable part when an old consumable part is replaced by the new consumable part, according to an exemplary embodiment of the present general inventive concept.

As illustrated in FIG. 5, the system 500 according to the present exemplary embodiment includes an image forming apparatus 510, a management server 520, and a host device 530.

The image forming apparatus 510 may transmit identification information of the image forming apparatus 510 and identification information of the consumable part to the management server 520 via a transceiving unit 410, when the old consumable part is replaced by the new consumable part. Here, the identification information may include serial numbers, names of manufacturers, serial numbers of the manufacturers, manufacture dates, or the like which are with respect to the image forming apparatus 510 and the consumable part.

The management server 520 may generate an executable file for the initialization with respect to the amount of use of the new consumable part. To be more specific, the management server 520 may receive the identification information of the image forming apparatus 510 and of the new consumable part from the image forming apparatus 510 via a transceiving unit 522, and an initialization determining unit 524 may compare the identification information of the new consumable part with identification information of consumable parts stored in a storage unit 526 and thus may determine whether the initialization with respect to the amount of use of the new consumable part has been already performed. Also, an executable file generating unit 528 may generate the executable file for the initialization with respect to the amount of use of the new consumable part, according to a result of the determination by the initialization determining unit 524. The management server 520 of the system 500 according to the present exemplary embodiment may generate an executable file for the initialization with respect to the amount of use of the new consumable part, and may store a list in the storage unit 526 by listing identification information in the list, wherein the identification information may include information regarding image forming apparatuses and consumable parts when an amount of use is initialized according to the generated executable file. Thus, if identification information, which corresponds to matching the identification information of the new consumable part, already exists in the management server 520, it may be determined that the new consumable part has already performed the initialization with respect to its amount of use, and thus an executable file for the initialization with respect to the amount of use of the consumable part may not be generated. That is, the management server 520 may generate an executable file to initialize the amount of use of the new consumable part only when identification information, which corresponds to matching the identification information of the new consumable part, does not exist in the storage unit 526. The generated executable file may be transmitted to the host device 530.

The host device 530 may receive the executable file to initialize the amount of use of the new consumable part from the management server 520 via a transceiving unit 532, may execute the received executable file in a central processing unit (CPU) 534, and may transmit an initialization execution command to the image forming apparatus 510 connected to the host device 530 via the transceiving unit 532, wherein the initialization execution command is for indicating the initialization with respect to the amount of use of the new consumable part. Also, the host device 530 may display the received executable file via a display unit 536.

Referring back to operations of the image forming apparatus 510, an initialization executing unit 440 of the image forming apparatus 510 may initialize the amount of use of the new consumable part according to the initialization execution command indicating initialization received from the host device 530. At this time, if identification information of an image forming apparatus included in the initialization execution command to indicate the initialization matches the identification information of the image forming apparatus 510, an initialization determining unit 430 of the image forming apparatus 510 may determine that the new consumable part is to undergo the initialization with respect to its amount of use. Also, after the initialization executing unit 440 of the image forming apparatus 510 initializes the amount of use of the new consumable part, the identification information of the new consumable part, when the amount of use of which has been initialized, may be stored in a storage unit 420 in a list. Thus, even if another initialization execution command to indicate initialization is received, if the initialization execution command includes the identification information of the new consumable part, the initialization with respect to the amount of use of the new consumable part may not be performed. In addition, the image forming apparatus 510 may display the received executable file via a display unit 460.

The exemplary embodiments of the present general inventive concept can be written as computer programs and can be implemented in general-use digital computers that execute the programs using a computer readable recording medium.

In addition, a data structure used in the exemplary embodiments of the present general inventive concept can be written in a computer readable recording medium through various means.

Examples of the computer readable recording medium may include magnetic storage media (e.g., ROM, floppy disks, hard disks, etc.), optical recording media (e.g., CD-ROMs, or DVDs), etc.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A method of initializing an amount of use of a new consumable part according to replacement of an old consumable part, the method comprising:
transmitting identification information of the new consumable part to a management server, when the old consumable part is replaced by the new consumable part excluding a memory in an image forming apparatus; and
determining whether initialization has been already performed by using an executable file.

2. The method of claim 1, wherein the determining comprises:
determining that the initialization has been already performed on the amount of use of the new consumable part, if identification information matching the identification information of the new consumable part is stored in the management server.

3. The method of claim 1, wherein the transmitting of the identification information comprises:
transmitting the identification information of the new consumable part along with the identification information of the image forming apparatus to the management server.

4. The method of claim 1, wherein the executable file comprises:
the identification information of the image forming apparatus, which performs the initialization of the new consumable part, and the identification information of the new consumable part.

5. The method of claim 4, further comprising:
storing the identification information of the image forming apparatus and the identification information of the new consumable part in the management server, wherein the identification information of the image forming apparatus and the identification information of the new consumable part are comprised in the executable file.

6. The method of claim 4, wherein the initializing of the amount of use of the new consumable part is performed when the identification information of the image forming apparatus matches the identification information of the image forming apparatus comprised in the executable file.

7. The method of claim 1, further comprising:
storing the identification information of the new consumable part in the image forming apparatus, after the amount of use of the new consumable part is initialized by the image forming apparatus.

8. The method of claim 7, wherein the initializing of the amount of use of the new consumable part comprises:
initializing the amount of use of the new consumable part by using the executable file, if the identification information of the new consumable part comprised in the executable file does not match the identification information of the new consumable part stored in the image forming apparatus.

9. The method of claim 1, wherein the initializing of the new consumable part comprises:
initializing the new consumable part by resetting a counter value of the new consumable part to “0”, wherein the counter value of the new consumable part is stored in the image forming apparatus.

10. The method of claim 1, wherein the transmitting of the executable file comprises:
transmitting the executable file to the image forming apparatus or a host device that is connected to the image forming apparatus.

11. The method of claim 10, further comprising:
displaying the executable file in the image forming apparatus or the host device, which receives the executable file, when the executable file is transmitted.

12. The method of claim 1, wherein the initializing of the amount of use of the new consumable part comprises:
starting the initializing of the amount of use of the new consumable part automatically or according to an initialization execution command from a user.

13. A computer readable recording medium to contain computer-readable codes as a program to execute a method of initializing an amount of a new consumable part according to replacement of an old consumable part by using a computer, the method comprising:
transmitting identification information of the new consumable part to a management server, when the old consumable part is replaced by the new consumable part excluding a memory in an image forming apparatus; and
determining whether initialization has been already performed by using an executable file.

14. An image forming apparatus to initialize an amount of use of a new consumable part according to replacement of an old consumable part, the image forming apparatus comprising:
a transceiving unit to transmit identification information of the new consumable part to an external server and receiving an executable file for initialization of the amount of use of the consumable part, when the old consumable part is replaced by the new consumable part excluding a memory;
a storage unit to store the executable file;
an initialization determining unit to determine whether initialization has been already performed on the amount of use of the new consumable part;
an initialization executing unit to initialize the amount of use of the new consumable part according to the executable file, based on a result determined by the initialization determining unit; and
a control unit to control the transceiving unit, the storage unit, the initialization determining unit, and the initialization executing unit to perform respective functions.

15. The image forming apparatus of claim 14, wherein the executable file comprises:
identification information of the image forming apparatus which performs the initialization of the new consumable part, and the identification information of the consumable part.

16. The image forming apparatus of claim 15, wherein the initialization executing unit performs the initialization of the amount of use of the new consumable part when the identification information of the image forming apparatus matches the identification information of the image forming apparatus comprised in the executable file

17. The image forming apparatus of claim 15, wherein the storage unit stores identification information of already-initialized consumable parts, and
wherein the initialization determining unit determines that the initialization of the amount of use of the new consumable part has not been performed, if the identification information of the consumable part comprised in the executable file does not match the identification information of the new consumable part which is stored in the storage unit.

18. The image forming apparatus of claim 14, further comprising a display unit to display the executable file.

19. The image forming apparatus of claim 14, wherein the storage unit stores a counter value of the new consumable part, and
wherein the initialization executing unit initializes the amount of use of the new consumable part by resetting the counter value of the consumable part to “0”, wherein the counter value of the consumable part is stored in the storage unit.

20. The image forming apparatus of claim 14, wherein the initialization executing unit starts the initializing of the amount of use of the new consumable part automatically or according to an initialization execution command from a user.

21. A system to initialize an amount of use of a new consumable part according to replacement of an old consumable part, the system comprising:
an image forming apparatus to transmit identification information of the new consumable part and identification information of the image forming apparatus, when the old consumable part is replaced by the new consumable part excluding a memory;
a management server to receive the identification information of the consumable part and the identification information of the image forming apparatus from the image forming apparatus, generating and transmitting an executable file for initialization of the amount of use of the new consumable part; and
a host device to receive the executable file from the management server, executing the executable file, and transmitting to the image forming apparatus an initialization execution command to indicate the initialization of the amount of use of the new consumable part,
wherein the image forming apparatus initializes the amount of use of the new consumable part according to the initialization execution command.

22. A method of performing a first time setup of a consumable part of an image forming apparatus, the method comprising:
broadcasting information unique to the image forming apparatus and the consumable part;
comparing the information with stored information; and
performing a first time setup of the consumable part if the information broadcast does not match with stored information.

23. The method of claim 22, wherein the information unique to the image forming apparatus is broadcast to a database server.

24. The method of claim 22, wherein the information unique to the image forming apparatus and the consumable part comprises:
serial numbers, names of manufacturers, serial numbers of the manufacturers, and manufacture dates.

25. The method of claim 22, wherein the consumable part comprises:
toner ink, ribbon cartridge, or ink cartridge.

26. An image forming system including a consumable part, comprising:
an image forming apparatus to broadcast unique identifiers of the image forming apparatus and consumable part; and
a database server to receive the broadcast unique identifiers, determine whether a first time setup of the consumable part has occurred, and transmit a first time setup executable file to the image forming apparatus if the first time setup is deemed necessary.

27. The image forming system of claim 26, wherein the first time setup executable file specifies the quantity to use of the consumable part during first time setup.

28. The image printing apparatus of claim 26, wherein the database server directly transmits the first time setup executable file to the image forming apparatus.
